(19) United States
(12) Patent Application Publication
(10) Pub. No.: US 2026/0020712 A1
(43) Pub. Date: Jan. 22, 2026

(54) SKILLET FOR USING CONVECTION ACTION IN A SEALED COMPARTMENT

(71) Applicant: Cleveland Range Ltd., Ontario (CA)

(72) Inventors: Joe A. Nicholson, Grafton, OH (US); Fady Nabil Khalil Guirguis, Mississauga, CA (US); Fadi Younan, Mississauga, CA (US); Jameel Ahmad, Richmond Hill (CA)

(73) Assignee: Cleveland Range Ltd., Ontario (CA)

(21) Appl. No.: 19/272,375

(22) Filed: Jul. 17, 2025

Related U.S. Application Data
(60) Provisional application No. 63/673,238, filed on Jul. 19, 2024.

(51) Int. Cl. A47J 27/092; A23L 5/10; A47J 27/04; A47J 36/06; A47J 36/32

(52) U.S. Cl. CPC A47J 27/092; A23L 5/13; A23L 5/17; A47J 27/04; A47J 36/06; A47J 36/32; A47J 2027/043

(57) ABSTRACT

The skillet of the present disclosure includes a pan, a lid, and a gasket so that when the lid is placed on top of the pan, the lid is sealed to the pan because of the gasket. An interior space is defined, so that water and food product to be cooked can be placed therein. A fan is connected to the lid and circulates air within the interior space. A heating element supplies heat energy to the pan. A pressure release valve is connected to the lid, as is a pressure sensor. A controller can receive pressure readings from the pressure sensor, and control the heating element, fan, and pressure release valve to keep the pressure in the interior space within a desired level.

### CROSS-REFERENCE TO RELATED APPLICATION

The present application claims the benefit under 35 U.S.C. § 119 of U.S. Provisional Patent Ser. No. 63/673,238, filed on Jul. 19, 2024, which is herein incorporated by reference.

### BACKGROUND OF THE DISCLOSURE

### 1. Field of the Disclosure

The present disclosure relates to a braising skillet. More particularly, the present disclosure relates to a braising skillet having a sealed lid and a fan therein, with a controller to control the pressure within the skillet.

### 2. Description of the Related Art

Conventional braising pots or cookers comprise a pot with an amount of water therein. The food product to be cooked sits in the water, and is cooked as heat is applied to the pot. These devices suffer from a lack of controllability of the amount of cooking and high cook times. Further, they are very energy inefficient, as heat (such as from a gas burner) is continuously being used to maintain the desired level of heat transfer to the food. Further, water vapor is lost to the ambient environment.

### SUMMARY OF THE DISCLOSURE

The present disclosure addresses these problems of current devices. The skillet of the present disclosure comprises a pan to which an amount of water can be added, and where the food to be cooked is placed. A lid covers the pan to create a cooking compartment. A fan is within the cooking compartment, to provide convection cooking. The lid is sealed with a gasket to the pan. As described in greater detail below, these features work together to provide steam retention, flavor retention, and a significant improvement in energy efficiency, among other advantages.

Along with these benefits come significant engineering and design challenges, as the pressure within the cooking compartment must be controlled to within desired and safe levels. The present disclosure also provides these controls.

Accordingly, in one embodiment the present disclosure provides a skillet for cooking food products, comprising: a pan, wherein the pan has a base and a side wall that projects up from the base, wherein the side wall has a rim at a top end, so that the pan is configured to hold the food products and an amount of liquid water; a gasket on the rim; a lid, wherein the lid covers the pan and contacts the gasket, so that the lid sealingly covers the pan, and so that an interior space is defined by the pan, the gasket, and the lid; and a fan connected to the lid, wherein the fan projects into the interior space.

In another embodiment, the present disclosure provides a method of cooking a food product in a skillet, wherein the skillet comprises: a pan, wherein the pan has a base and a side wall that projects up from the base, so that the pan is configured to hold the food products and an amount of liquid water; a lid, wherein the lid covers the pan and sealingly engages the pan via a gasket, so that an interior space is defined by the pan, the gasket, and the lid; and a fan connected to the lid, wherein the fan projects into the interior space. The method comprises the steps of: placing an amount of water and the food product in the pan; heating the pan, so that the water and the food product are heated; controlling the fan to circulate air within the interior space; measuring the pressure of air and/or water vapor within the interior space to produce a pressure reading; and controlling the pressure of the air and/or water vapor in the interior space based on the pressure reading.

For ease of description, the present disclosure uses the term “skillet” to refer to the device of the present disclosure, and a “pan” as one component of that device. Cooking equipment that can be used for braising food is also sometimes known as a “braising pan,” “braising skillet,” “tilt skillet,” or other terms.

### BRIEF DESCRIPTION OF THE FIGURES

FIG. 1 shows a top, perspective view of a skillet of the present disclosure.

FIG. 2 shows a cross-sectional view of the skillet of FIG. 1.

FIG. 3 shows a top, transparent view of the skillet of FIG. 1.

FIG. 4 shows a theoretical schematic of a food product being cooked in a skillet of the prior art.

FIG. 5 shows a theoretical schematic of a food product being cooked in the skillet of the present disclosure.

FIG. 6 shows an alternative embodiment of the skillet of FIG. 2.

### DETAILED DESCRIPTION OF THE DISCLOSURE

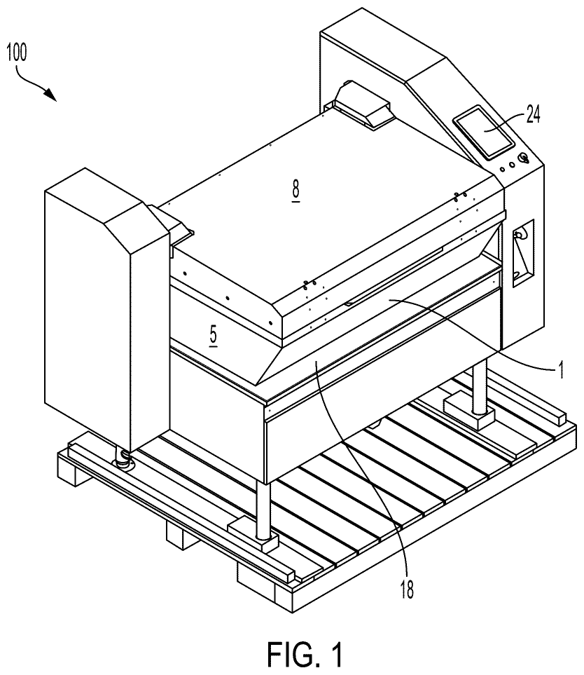

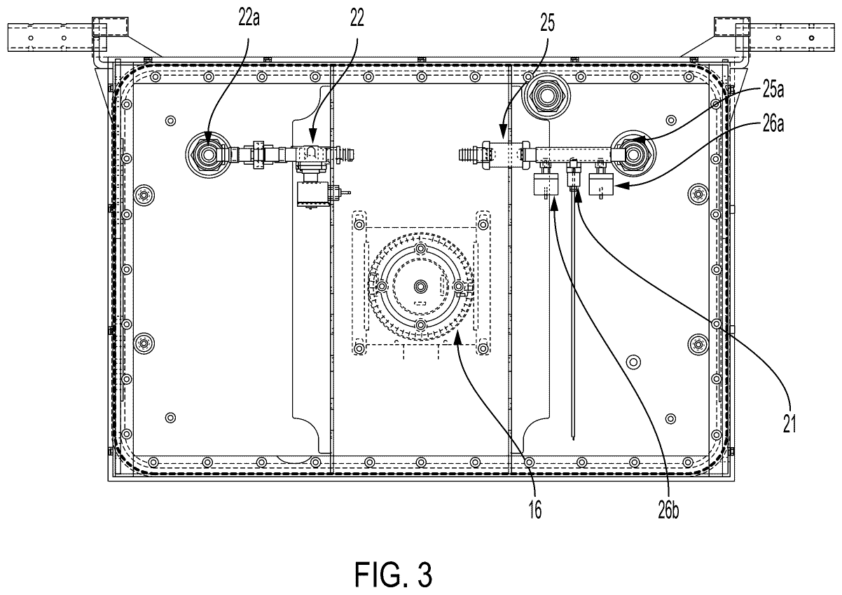

Referring to the Figures, and in particular FIGS. 1-3, skillet 100 of the present disclosure is shown. Skillet 100 has a pan 1 that has a bottom surface 3, side walls 5 and a rim 7 that is at the top of side walls 5. In the shown embodiments, pan 1 is rectangular in shape, but other shapes are contemplated, such as circular. Lid 9 sits on rim 7, and the two components are sealed to one another with a gasket 10. An interior space 12 is thus defined by bottom surface 3, side walls 5, gasket 10, and lid 9. A food product 13 to be cooked sits on bottom surface 3, in an amount of water 14. Gasket 10 prevents or mitigates the escape of pressure and/or heat from interior space 12.

Fan 16 is connected to lid 9 and projects into interior space 12 to circulate air and/or vapor therein. Pan 1 sits on top of a clad plate 18, which in turn sits on top of a heating element 20. Heating element 20 may be gas, electric, or inductive, and may also be integrated into clad plate 18. Heating element 20 may also apply heat directly to pan 1 without clad plate 18. The water 14 and air/vapor within interior space is heated by element 20, and circulated in a turbulent flow by fan 16. The pressure in interior space 12 is monitored by a pressure sensor/transmitter 21, which is connected to lid 9. An electrical pressure release valve 22 can also help regulate the pressure within interior space 12 in the manner described below.

An outer cover 8 may protect transmitter 21, fan 16, and electrical pressure release valve 22 from the ambient environment. A controller 24 is in communication with transmitter 21, fan 16, and electrical pressure release valve 22. Controller 24 has an input/outboard (I/O) board 29 thereon. Transmitter 21, fan 16, heating element 20, and electrical pressure release valve 22 are each connected to I/O board 29. Firmware 30 resides on I/O board 29. Controller 24, via I/O board 29 and firmware 30, controls fan 16, heating element 20, and electrical pressure release valve 22 to maintain a desired pressure value in interior space 12 based on a pressure reading that transmitter 21 sends to controller 24. Controller 24 may be on a panel in skillet 100, as shown in FIG. 1, or it may be a portable device. The above-described components can be connected to I/O board 29 via wired or wireless connections. I/O board 29 can communicate with a user interface 31 on controller 24, via methods such as Modbus and/or RS-485.

Accordingly, skillet 100 provides several advantages that are not available in current braising systems. In the manner described in detail below, the pressure within interior space 12 is continuously and closely monitored, so that it stays within a desired value. Fan 16 circulates heated air, which significantly improves the amount of heat delivered to the food product 13. Because of this convection heating in combination with precise pressure control, skillet 100 achieves significant improvements in cooking time, energy or fuel use, water use, retention of steam/water vapor, and flavor enhancement. The pressure within interior space 12 can be kept at a value where it is safe for a user to remove lid 9 to check on food product 13, and where the pressure within interior space returns to that level quickly.

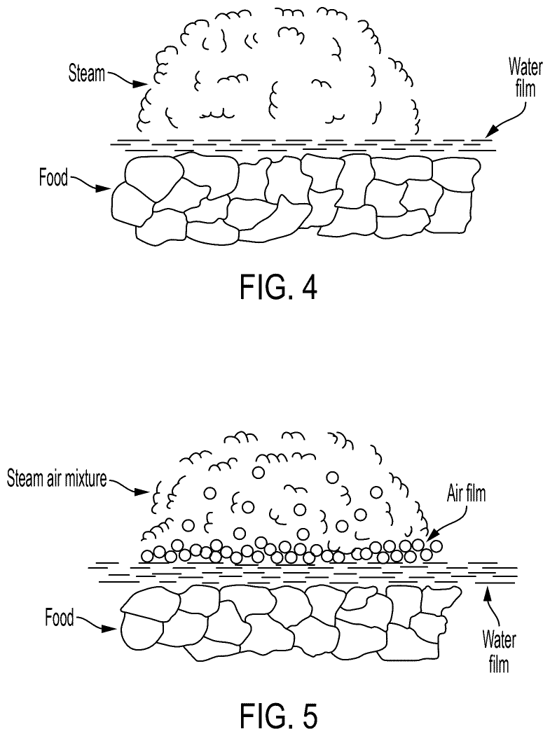

Referring to FIGS. 4 and 5, theoretical schematic drawings of the cooking environment are shown. Since steam in a conventional braising pan skillet is the heat transfer fluid, a phase change from vapor to water (i.e., condensation) takes place on or near the surface of the food in both conduction and convection heat transfer. This condensation produces a liquid film on the surface of the food as the steam transfers its latent heat to the food. The heat transfer to the food must pass through this liquid film, which on one side is in contact with the food and on the other side with the vapor. This liquid film on the food may significantly impede the cooking process. The extent and nature of this impediment depends on the thickness and motion of the liquid film, which in turn depends on the motion of the vapor. This is depicted in FIG. 4.

By contrast, as illustrated in FIG. 5, in skillet 100 the convection feature of the braising pan enhances heat circulation within interior space 12, promoting uniform cooking and reducing cooking time. Without wishing to be bound by theory, this feature is at least partially explained by the forced convection induced by fan 16. When forced convection is applied to the liquid film around the food, the film is thinned. The heat transfer coefficient between the air or vapor within interior space 12 can be as much as 10 times as large as those with those skillets where convection is not used, i.e., those with negligible vapor velocities. Furthermore, the shear stress on the condensate due to the air, steam, and vapor flow increases the liquid flow of the water, where the food is being cooked, and causes ripples on the liquid film around the food. This also enhances the heat transfer. The present inventors observed that the shear stress effect can augment heat transfer to the food by 20%, and the convection effect by even greater amounts. The enhanced heat transfer achieved by the skillet of the present disclosure also provides more thorough cooking of the food product. Conventional skillets without sealed covers rely on conduction cooking and any natural convection currents that may occur within the pan, which would be minimal.

One of the reasons why it was previously not thought possible or desirable to produce a sealed braising skillet is that the pressure within a sealed cooking vessel that is continuously supplied with heat energy can rise to dangerous levels. Most pressurized cooking devices also do not give the user the ability to check on the food as it is being cooked. They often need to be sealed with mechanical devices, due to the high pressure inside. With skillet 100, by contrast, the present inventors have discovered a way to monitor and control the pressure within interior space 12, while still being convenient for the user during cooking. In one embodiment skillet 100 does not have any device or mechanical component that rigidly connects lid 9 to pan 1, impedes the ability of an operator to lift lid 9 away from pan 1, or which an operator would have to remove or release in order to lift lid 9 away from pan 1. When pressures in interior space 12 are low, for example less than 1 p.s.i., a locking system for lid 9 is not needed. When pressures are higher, a locking system is likely required. In one embodiment, skillet 100 operates so that the pressure in interior space 12 does not exceed 1 p.s.i.

Electrical pressure release valve 22 has several functions. It can be used to vacuum air out of interior space 12 before a cooking operation takes place. It can also function as a release path for steam pressure at the end of a cooking cycle before the operator can lift lid 9. Electrical pressure release valve 22 also has a safety function, in that it opens and vents through pressure port 22a if the pressure within interior space 12 is above a desired safety pressure rating. Pressure port 22a releases to a vent or drain. This is in addition to mechanical pressure relief valve 25, which is also part of skillet 100. Pressure sensor/transmitter 21 continually measures the pressure in interior space 12 and compares the obtained readings to those obtained by pressure switches 26a and 26b, an additional level of safety check. When pressure transmitter 21 determines that the pressure in interior space 12 is above a desired safety value, transmitter 21 communicates that to controller 24, which in turn sends a signal to electrical pressure release valve 22 to open and release the pressurized air and/or steam within interior space 12, until the pressure returns to a safe level. Mechanical pressure release valve 25 is factory-set to release pressure (via pressure port 25a, which can be released through a drain or vent) when the pressure detected by sensor 21 rises above a certain threshold and is an additional safety feature if power is lost to skillet 100. In this way, skillet 100 provides several levels of safety control to guard against dangerous pressure levels.

Elaborating on the preceding paragraph, as previously discussed pressure switches 26a and 26b and/or pressure transmitter 21 are in communication with I/O board 29 of controller 24. Pressure transmitter 21 can give continuous readings to controller 24. High-pressure switch 26a is configured so that once a certain preset factory pressure is reached, switch 26a either opens or closes (depending on the default setting) and gives an input of zero or one voltage data to controller 24. Controller 24 compares the values provided by pressure transmitter 21 to the reading of pressure switches 26a and 26b and makes sure the two data values are within an acceptable tolerance/difference. If the values are not within this tolerance, controller 24 puts skillet 100 into an error state, where skillet 100 is not functional until the error is addressed. That is, in one example pressure switch 26a can be factory set to send a “one” signal to controller 24 when the reading on pressure switch 26a reaches ˜0.5 p.s.i. At this exact instant, pressure transmitter 21 should also be reading ˜0.5 p.s.i. If not, controller 24 places device 100 into an error state. Operating pressure switch 26b sends a signal to controller 24 to maintain the system pressure to operate within the designated operating pressure range. Switch 26b is on and sends a signal to controller 24 as long as the pressure is within a desired limit. As one non-limiting example, if the pressure in space 12 is less than 0.5 psi, operating switch 26b continues to signal the controller 24, and shuts off when the pressure goes above 0.5 psi.

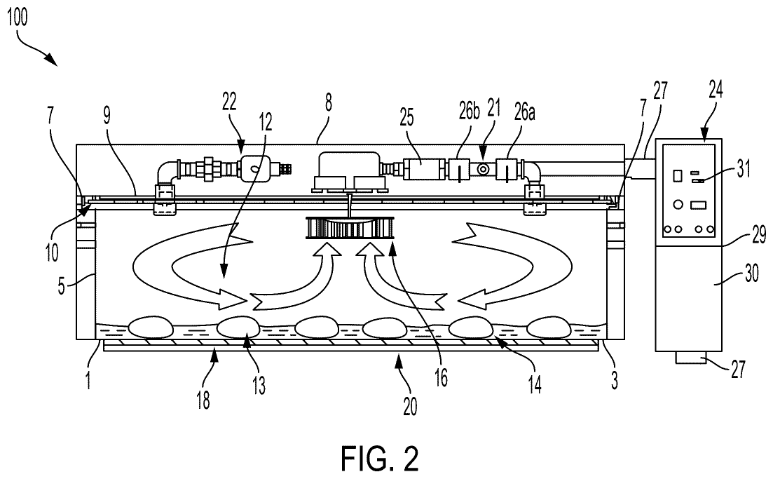

Controller 24 can be on a panel of skillet 100, as shown in FIG. 1, or can be remote or portable, as shown in FIG. 2. In the shown embodiment, electrical pressure release valve 22, fan 16, and sensor 21 are all connected to and sealed to lid 9, and in communication with interior space 12. Electrical pressure release valve 22, fan 16, and/or sensor 21 can also be connected to other parts of pan 3, such as one or both of side walls 7. In one embodiment, the pressure within interior space 12 can be controlled to be at or about 0.5 p.s.i. The pressure in interior space 12 can be controlled to higher or lower values depending on the type of food product 13 that is being prepared, for example from 0.5 p.s.i. to 5.5 p.s.i., or any subranges therebetween. In one embodiment, the speed of fan 16 can be at or about 3000 revolutions per minute (rpm). The speed of fan 16 can be from 1500 rpm to 3000 rpm, or any subranges therebetween, and can be controlled by controller 24. At these values, the high cooking rate and heat transfer discussed above is achieved, but an operator will be able to remove lid 9 to check on food products 13 during a cooking cycle. This controlled pressure also ensures that the heat is evenly distributed within interior space 12, facilitating thorough cooking while retaining moisture and flavor within food product 13.

Additionally, the present inventors discovered that by vacuuming out air (oxygen) from interior space 12 at the beginning of a pressure cooking cycle, significantly improved cooking can be achieved in a low oxygen environment. The present inventors observed that as little as one percent by volume of a non-condensable gas in a steam environment can reduce heat transfer coefficients by ½ or ⅓. In other words, the heat transfer coefficient in a pure steam environment can be 200-300% greater than in a steam environment contaminated by air. Controller 24 can control valve 21 to remove (e.g., vacuum) air out of interior space 12 before a pressure cooking mode.

Pan 1 can be made of a clad material, i.e., a composite of two more materials, or it can be made of a single material such as stainless steel, carbon steel, aluminum, or an iron-containing metal such as cast iron. In one embodiment, pan 1 is made of a two-layer material that has a carbon steel base plate and top layer plate of 304 stainless steel. Gasket 10 should be made of a food-safe material that can withstand high heat. In one embodiment, gasket 10 is made of silicone. Gasket 10 can be one continuous part that covers the entire rim 7, or it can be two or more separate pieces on rim 7 to effect the seal between pan 1 and lid 9. The materials and thickness of clad plate 18 should be selected to provide structural integrity and support for pan 1, and facilitate heat transfer from elements 20 to pan 1 and food products 13. Clad plate 18 can be one single layer of a material, or a composite of two or more layers. The materials for clad plate 18 can be carbon steel, stainless steel, or aluminum. In one embodiment, clad plate 18 is a three-layer composite, with a steel layer under one or more layers of 304 stainless steel. The overall thickness of clad plate 18 can be from ⅜ths of an inch to ⅝ths of an inch, or any subranges therebetween.

Skillet 100 can also have a drain line 27 that removes excess moisture or steam buildup from skillet 100, directing it to a proper drainage system during cooking cycles or when the pressure safety relief valve opens. Drain line 27 can be connected to interior space 12 via pan 1 and a solenoid valve. The solenoid valve opens and closes based on the cooking cycle, controlled by controller 24. Drain line 27 can also be connected to pressure safety relief valve 25. Drain line 27 can run to a console of skillet 100, and/or can connect to a building's drain system.

The following disclosure relates to additional features or embodiments of skillet 100.

Alternative methods of promoting heat circulation may be employed, in lieu of or in conjunction with fan 16. Instead of a convection fan, skillet 100 could incorporate stirring or agitation mechanisms to facilitate heat distribution, circulation and ensure uniform cooking. Jet systems within the lid 9 could inject a high flow of air into interior space 12, to achieve the heat circulation and distribution of heat around the product surface. Rotating trays or shelves could be placed within interior space 12 to evenly expose ingredients to the heating elements. A grill bed could be selectively raised and lowered by one or more (e.g., four) linear actuators disposed around interior space 12 (e.g., at the corners). This would allow for the raising of food products 13 out of the water 14, and allow steam to fully circulate around the food 13 being cooked, further improving the cooking of food 13.

Heating element(s) 20 may vary in type and configuration depending on specific design requirements and preferences. Alternatives to electric or gas heating elements 20 include induction heating technology to generate heat directly within the cooking vessel, offering precise temperature control and energy efficiency. Heating elements 20 could also be infrared heating elements to deliver intense, focused heat to the cooking surface, facilitating rapid and efficient cooking (i.e., via radiation heating). Microwave technology can also be used alongside heating elements 20, to accelerate cooking times and promote even heating (also via radiation heating).

Alternatives to gasket 10 could include silicone-based gaskets, which can offer flexibility, durability, and heat resistance. Rubber may also be a suitable material. A lid design featuring clamp-down mechanisms or latches to ensure a secure seal could also be used. Skillet 100 could also utilize vacuum-sealing technology to remove air from the compartment and enhance pressure control and sealing during cooking.

In addition to heating element 20, heating elements can be strategically placed near the fan 16. These elements provide direct heat to the circulating air, promoting rapid and efficient cooking, particularly suitable for air frying. These additional heaters may be electric heating coils positioned adjacent to fan 16 to generate intense heat, mimicking the effects of traditional deep frying. Infrared heating panels may also be incorporated near fan 16 to deliver focused heat directly to the cooking surface, promoting crispiness and browning in air fried foods. The present disclosure also contemplated using halogen lamps as heating elements to produce instant, radiant heat that evenly distributes throughout the cooking chamber, enhancing air frying capabilities.

While the integration of heating elements near the fan enables air frying functionality, alternative methods for achieving similar results may be considered. These include enhancing the convection fan's power and efficiency to create strong air currents that effectively circulate hot air around the food, promoting even cooking and crispiness. The present disclosure also contemplates providing an operator of skillet 100 with the option to attach an oil sprayer accessory to pan 1 or at another point, allowing for the addition of small amounts of oil to achieve crispy golden-brown textures in air-fried foods. A rotisserie attachment could also be placed within interior space 12, allowing for the rotation of food items 13 while they are exposed to the circulating hot air, promoting uniform cooking and browning. In the air-frying embodiment, the food products could be raised on a tray or pan with perforations or slots therein, so that air can circulate around the food products.

The incorporation of air frying capabilities introduces additional parameters for temperature and cooking time control. Ranges for air frying may vary based on the desired level of crispiness and browning, as well as the specific food being prepared. The present disclosure contemplates that the temperature settings on skillet 100 can be adjustable, and from 250 degrees Fahrenheit to 475 degrees Fahrenheit (120 degrees Celsius to 232 degrees Celsius), or any subranges therebetween. The cooking time can be from a few minutes to several hours, or any subranges therebetween, depending on the type and quality of food being air fried, as well as desired doneness levels. These temperature and time parameters apply to all embodiments of skillet 100.

Skillet 100 may also be what is known as a “tilt skillet”. Pan 1, either alone or with lid 8 and the components connected thereto, can rotate with respect to a base holding skillet 100. This rotation provides easier access for a user to the contents of interior space 12.

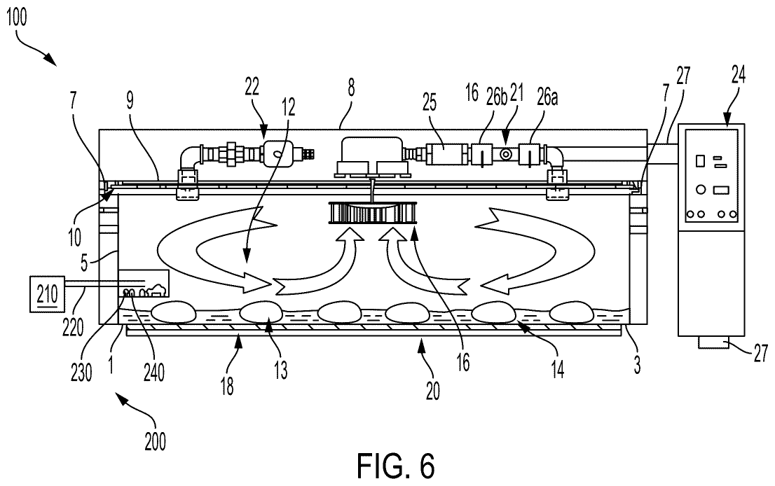

Skillet 100 can also be used in conjunction with a smoker or smoker device, such as that found in U.S. Pat. No. 8,304,697. One embodiment of skillet 100 with a smoker is shown in FIG. 6. Smoker 200 has power source 210, heating element 220, and tray 230. Wood chips 240 or other material capable of producing smoke can be in tray 230. In this way, the smoke that wood chips 240 give off provides an additional flavor to food products 13.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A skillet for cooking food products, comprising:
a pan, wherein the pan has a base and a side wall that projects up from the base, wherein the side wall has a rim at a top end, so that the pan is configured to hold the food products and an amount of liquid;
a gasket on the rim;
a lid, wherein the lid covers the pan and contacts the gasket, so that the lid sealingly covers the pan, and so that an interior space is defined by the pan, the gasket, and the lid; and
a fan connected to the lid, wherein the fan projects into the interior space.

2. The skillet of claim 1, further comprising a clad plate connected to the base of the pan on a side of the base opposite the interior space.

3. The skillet of claim 2, further comprising a heating element connected to the clad plate on a side of the clad plate that is opposite the base of the pan, wherein the heating element provides heat to the pan to heat the liquid and/or the interior space.

4. The skillet of claim 1, further comprising a pressure relief valve connected to the lid, wherein the pressure relief valve is in fluid communication with the interior space and the ambient environment outside the skillet, wherein the pressure relief valve is configured to release pressure from the interior space to the ambient environment.

5. The skillet of claim 4, wherein the pressure relief valve is an electrical pressure relief valve.

6. The skillet of claim 4, wherein the pressure relief valve is a mechanical pressure relief valve.

7. The skillet of claim 1, further comprising a pressure sensor connected to the lid, wherein the pressure sensor measures a pressure in the interior space.

8. The skillet of claim 4, further comprising a pressure sensor connected to the lid, wherein the pressure sensor measures a pressure in the interior space.

9. The skillet of claim 8, wherein the pressure relief valve is an electrical pressure relief valve.

10. The skillet of claim 9, further comprising a second pressure relief valve, wherein the second pressure relief valve is a mechanical pressure relief valve.

11. The skillet of claim 8, further comprising a heating element, wherein the heating element provides heat to the pan to heat the water and/or the interior space.

12. The skillet of claim 11, further comprising a controller, wherein the fan, the electrical pressure relief valve, the pressure sensor, and the heating element are each in communication with the controller, wherein the controller is configured to receive a pressure reading from the pressure sensor and control the heating element, the fan, and/or the pressure relief valve to maintain a set pressure in the interior space based on the pressure reading.

13. A method of cooking food product in a skillet, wherein the skillet comprises:
a pan, wherein the pan has a base and a side wall that projects up from the base, so that the pan is configured to hold the food products and an amount of liquid water;
a lid, wherein the lid covers the pan and sealingly engages the pan via a gasket, so that an interior space is defined by the pan, the gasket, and the lid;
a fan connected to the lid, wherein the fan projects into the interior space,
the method comprising the steps of:
placing an amount of water and the food product in the pan;
heating the pan, so that the water and the food product are heated;
controlling the fan to circulate air within the interior space;
measuring the pressure of air and/or water vapor within the interior space to produce a pressure reading; and
controlling the pressure of the air and/or water vapor in the interior space based on the pressure reading.

13. The method of claim 12, further comprising the step of evacuating at least a portion of the air within the interior space.

14. The method of claim 12, wherein the controlling step comprises at least one of the following: releasing an amount of air and/or water vapor in the interior space; adjusting a speed of the fan; and adjusting an amount of heating that is supplied to the pan.

15. The method of claim 12, wherein the skillet further comprises;
a pressure release valve connected to the lid; and
a heating element connected to the pan, wherein the heating element supplies heat to the pan, to heat the water and/or the food product,
wherein the controlling step comprises at least one of the following: controlling the pressure release valve to release an amount of air and/or water vapor from the interior space into an ambient environment outside the skillet; adjusting a speed of the fan; and adjusting an amount of heating that is supplied to the pan by the heating element.
